(19) United States
(12) Patent Application Publication
(10) Pub. No.: US 2019/0332577 A1
(43) Pub. Date: Oct. 31, 2019

(54) DATA ACCESS METHOD BASED ON FEATURE ANALYSIS, STORAGE DEVICE AND STORAGE SYSTEM

(71) Applicant: SHENZHEN DAPU MICROELECTRONICS CO., LTD., Shenzhen (CN)

(72) Inventors: Qing Yang, Shenzhen (CN); Weijun Li, Shenzhen (CN)

(73) Assignee: SHENZHEN DAPU MICROELECTRONICS CO., LTD., Shenzhen (CN)

(21) Appl. No.: 16/508,293

(22) Filed: Jul. 10, 2019

Related U.S. Application Data
(63) Continuation of application No. PCT/CN2017/100424, filed on Sep. 4, 2017.

(30) Foreign Application Priority Data
May 10, 2017 (CN) 201710323317.2

(51) Int. Cl. G06F 16/13; G06F 16/14; G06F 13/42

(52) U.S. Cl. CPC G06F 16/137; G06F 16/148; G06F 2213/0032; G06F 2213/0026; G06F 2213/0028; G06F 13/4221

(57) ABSTRACT

The present disclosure discloses a data access method based on feature analysis, storage device and storage system. The method includes performing file feature analysis on a file to be stored to obtain a file feature value of the file to be stored. The storage device generates a file feature value record based on the file feature value of the file to be stored, and stores the file feature value record and a corresponding relation of the file feature value record and the file to be stored to a preset mapping table. The storage device generates a condition file feature value corresponding to a data management instruction when receiving the data management instruction from a storage server. The condition file feature value is configured to characterize a query condition of the data management instruction. The storage device obtains the filename or the physical address of a target file by matching the condition file feature value to the file feature value record in the preset mapping table.

### CROSS-REFERENCE TO RELATED APPLICATION(S)

This present application is a continuation of International Application No. PCT/CN2017/100424, filed on Sep. 4, 2017, which claims priority to Chinese Patent Application No. 201710323317.2, filed on May 10, 2017, and entitled “DATA ACCESS METHOD BASED ON FEATURE ANALYSIS , STORAGE DEVICE AND STORAGE SYSTEM”, the entire contents of both applications are incorporated by reference.

### TECHNICAL FIELD

This disclosure relates to the field of computers, and more particularly to a data access method based on feature analysis , storage device and storage system.

### BACKGROUND

With the popularity of the Internet and the rapid development of technologies such as the Internet of Things and big data computing in various fields, the generation of data is also growing explosively, which makes the performance and efficiency of data storage systems in the prior art unable to meet current demands gradually.

Specifically, the current data storage system needs to process an increasing amount of data, and the efficiency requirements for data processing are also increasing. In the prior art, the data storage system is able to control the access and management of the data of storage devices in the whole data storage system through a control device set in a specific storage server.

The inventors have found through research that at least the following defects exist in the prior art.

As the amount of data continues to grow, the performance and efficiency of storage systems will gradually decline.

### SUMMARY

Disclosed herein are technical solutions to increase performance and efficiency of data storage system.

In accordance with a first aspect of the present disclosure, the embodiments of the present disclosure provide a data access method based on feature analysis, the method may include.

S11, a storage device performs file feature analysis on a file to be stored obtained from a storage server, and obtains a file feature value of the file to be stored before storing the file to be stored. The file feature value is a feature attribute set predefined based on a preset rule and configured to characterize the attributes of the file to be stored. The feature attribute set includes a content characteristic subset for characterizing the content characteristics of the file to be stored.

S12, the storage device generates a file feature value record according to the file feature value of the file to be stored, and stores the file feature value record and the corresponding relation between the file feature value record and the file to be stored to a preset mapping table.

S13, when the storage device receives a data management instruction from the storage server, the storage device may generate a condition file feature value corresponding to the data management instruction. The condition file feature value is used to characterize a query condition corresponding to the data management instruction.

S14, the storage device may match the file feature value record in the preset mapping table according to the condition file feature value, and obtain a target file.

Preferably, in the embodiments of the present disclosure, the attributes may include.

An acquisition time, an acquisition location, and a file type of the file to be stored.

Preferably, in the embodiments of the present disclosure, the feature attribute set may include.

The attributes may include an age, a gender and an appearance of a character when the file to be stored is an image file including the character. The attributes may include a brand and a license plate number of a vehicle when the file to be stored is an image file including the vehicle.

Preferably, in the embodiments of the present disclosure.

The generating a file feature value record based on the file feature value of the file to be stored and the storing the file feature value record and a corresponding relation of the file feature value record and the file to be stored to a preset mapping table which may include:

Generating a corresponding hash value based on the file feature value of the file to be stored.

Establishing a bit mapping table of a filename of the file to be stored and the hash value.

In accordance with a second aspect of the present disclosure, a storage device based on feature analysis is provided. The storage device may include a data interface, a processor, a function unit and a storage medium for storing files.

The data interface may include a host interface configured for data interaction with a storage server.

The function unit may include.

A feature analysis module configured to perform file feature analysis on a file to be stored obtained from a storage server to obtain a file feature value of the file to be stored before storing the file to be stored, the file feature value being a feature attribute set predefined based on a preset rule and configured to characterize the attributes of the file to be stored, and the feature attribute set including a content characteristic subset for characterizing the content characteristics of the file to be stored.

An association module configured to generate a file feature value record based on the file feature value of the file to be stored and store the file feature value record and a corresponding relation of the file feature value record and the file to be stored to a preset mapping table.

An instruction parsing module configured to generate a condition file feature value corresponding to a data management instruction when receiving the data management instruction from the storage server, the condition file feature value being configured to characterize a query condition of the data management instruction.

A matching module configured to obtain a target file by matching the condition file feature value to the file feature value record in the preset mapping table.

The processor may be configured to provide data processing capability to the modules of the function unit.

Preferably, in the embodiments of the present disclosure, the storage medium may include a storage unit of flash memory type.

Preferably, in the embodiments of the present disclosure, the data interface may include.

A peer interface configured for communication connection of data with a storage medium of an adjacent storage device in a storage system.

Preferably, in the embodiments of the present disclosure, the host interface may include one or any combination of interfaces of PCIe interface, SAS interface, SATA interface, RapidIO interface, and NVMe interface.

The peer interface may include one or any combination of interfaces of Ethernet interface, FC interface, iSCSI interface and SAN interface.

In accordance with a third aspect of the present disclosure, a storage system based on feature analysis is provided. The storage system may include a storage server and a storage device.

The storage device may include a data interface, a processor, a function unit and a storage medium for storing files.

The data interface may include a host interface configured for data interaction with a storage server.

The function unit may include.

A feature analysis module configured to perform file feature analysis on a file to be stored obtained from a storage server to obtain a file feature value of the file to be stored before storing the file to be stored, the file feature value being a feature attribute set predefined based on a preset rule and configured to characterize the attributes of the file to be stored, the feature attribute set including a content characteristic subset for characterizing the content characteristics of the file to be stored.

An association module configured to generate a file feature value record based on the file feature value of the file to be stored and store the file feature value record and a corresponding relation of the file feature value record and the file to be stored to a preset mapping table.

An instruction parsing module configured to generate a condition file feature value corresponding to a data management instruction when receiving the data management instruction from the storage server, the condition file feature value being configured to characterize a query condition of the data management instruction.

A matching module configured to obtain a target file by matching the condition file feature value to the file feature value record in the preset mapping table.

The processor may be configured to provide data processing capability to the modules of the function unit.

Preferably, in the embodiments of the present disclosure, the storage system may include two or more storage devices.

The storage system as provided in the embodiments of the present disclosure has a distributed processing structure, i.e., the storage server and the storage device both have a function of data processing. When storing a file, the file feature value of the file to be stored may be extracted, and the filename of the file to be stored may be correlated with the file feature value, then the correlation may be recorded to a preset mapping table and the file may be stored. Thus, when retrieving and reading files, the storage device can acquire or generate a corresponding condition file feature value according to a data management instruction of the storage server. Then, a corresponding target file may be obtained in the storage medium by retrieving the filename of a corresponding target file in the storage medium or the physical address of the target file in the storage device via the preset mapping table according to the condition file feature value as the matching parameter. Then the target file may be uploaded to the storage server.

In the prior art, in content addressable storage which is close to the present disclosure, general approaches are, computing and generating a fingerprint of the content of each data access unit, and performing matching and retrieval of file or data. In the above prior art, although finding data that match the content of file or data in bulk data can be effectively performed, but it is difficult to perform classified search and retrieval on all file or data that includes a characteristic. Through the embodiments of the present disclosure, files that meet condition file feature value can be retrieved, thus increasing the efficiency of data retrieval. Through the embodiments of the present disclosure, by the process of file feature value extraction and matching of the storage file, the search and retrieval efficiency of file can be improved, and the required file can be conveniently and accurately obtained, thereby improving the efficiency of file retrieval.

On the other hand, since the embodiments of the present disclosure can perform preliminary processing of file management in the storage device, files can be preliminarily filtered. The preliminary filtering can effectively reduce the amount of data transmission from the storage device to the storage server, so it can also effectively reduce the network load of the entire storage system and improve the transmission efficiency of effective files, and thus improve efficiency of the storage system from another aspect.

### BRIEF DESCRIPTION OF THE DRAWINGS

To describe technical solutions in embodiments of the present disclosure or in the related art more clearly, the following briefly introduces the accompanying drawings required for describing the embodiments or the related art. Apparently, the accompanying drawings in the following description illustrate merely some embodiments of the present disclosure. Those of ordinary skill in the art may also obtain other drawings based on these accompanying drawings without creative efforts.

FIG. 1 is a schematic diagram of the steps of a data access method in accordance with some embodiments of the present disclosure;

FIG. 2 is a schematic structural diagram of a storage system in accordance with some embodiments of the present disclosure;

FIG. 3 is another schematic structural diagram of a storage device in accordance with some embodiments of the present disclosure.

### DETAILED DESCRIPTION

In order to enable those skilled in the art to better understand solutions of the present disclosure, technical solutions in the embodiments of the present disclosure will be described clearly and completely hereinafter with reference to the accompanying drawings in the embodiments of the present disclosure. Apparently, the described embodiments are merely some rather than all embodiments of the present disclosure. All other embodiments obtained by those of ordinary skill in the art based on the embodiments of the present disclosure without creative efforts shall fall within the protecting scope of the present disclosure.

Through research, the inventor found that the performance and efficiency of storage system is constantly decreasing as the amount of data is increasing. The reason is that the constantly increasing data also accordingly increases the processing load of storage server in data storage system. Moreover, the constantly increasing data also accordingly increases the number of storage units and the data transmission load of the whole data storage system network, thereby reducing the performance of data management of the whole data storage system.

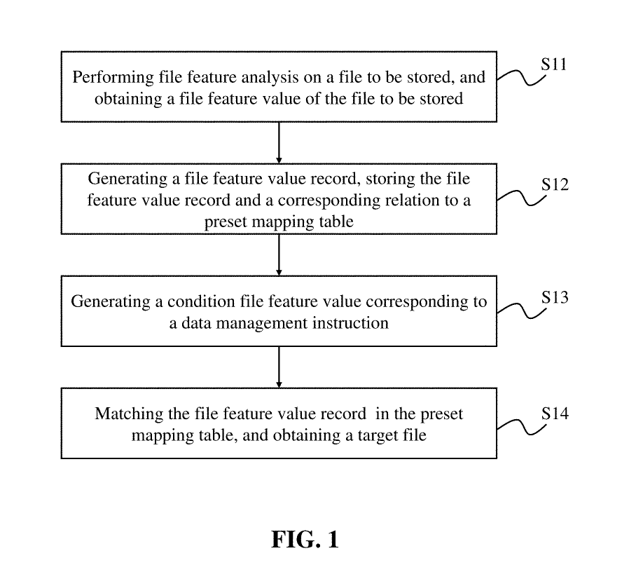

Based on the above research, the embodiments of the present disclosure provide a data access method based on feature analysis, referring to FIG. 1 to FIG. 3, the method includes.

S11, a storage device performs file feature analysis on a file to be stored obtained from a storage server, and obtains a file feature value of the file to be stored before storing the file to be stored. The file feature value is a feature attribute set predefined based on a preset rule and configured to characterize the attributes of the file to be stored. The feature attribute set includes a content characteristic subset for characterizing the content characteristics of the file to be stored.

In the embodiments of the present disclosure, the core idea is to distributedly design the process of data management processing of the entire storage system to be implemented in a server and a terminal. Specifically, part of the processing can be performed by the storage server 02 (as a server), the other part of the processing can be performed by the storage device 01 (as a terminal). For example, local data management which can be performed by the storage device 01 may include query, classification, analysis, hash computation, and data conversion of data. In other words, the operations and processing of data management are not performed by the storage server 02.

It should be noted that the data processing methods of local data management as described in the present disclosure (query, classification, analysis, hash computation, and data conversion) are only typical examples of specific applications of data management processing performed by the storage device 01, and not limited herein. Persons having ordinary skills in the art can design the processing functionality based on actual needs, the design shall fall into the protecting scope of the embodiments of the present disclosure.

In the embodiments of the present disclosure, operations such as file (data) storing and file (data) reading based on different applications may be implemented by a storage system, for example, storing video frame files acquired by a camera.

Taking a storage device as the executor, the process of file access includes a file storage process and a file retrieval process.

The storage device can receive a file to be stored according to instructions of a storage server. Before storing the file to be stored, the file to be stored is analyzed based on file feature value analysis to obtain the file feature value of the file to be stored. In some embodiments of the present disclosure, the file feature value refers to a predefined feature attribute set configured to characterize the attributes of the file to be stored. In practical applications, the attributes set may be various, and are defined according to different applications. When the file to be stored is an image file including a character. The attributes may include the age, gender, and appearance of the character. When the file to be stored is an image file including a vehicle, the attributes may include a brand and a license plate number of the vehicle. For example, for video frame files obtained by a camera, the content characteristic in the picture of the video frame may be defined as the file feature value. Specifically, the brand and the license plate number of the vehicle may be predefined as the file feature value respectively. Meanwhile the gender, age, or appearance of the character may also be predefined as the file feature value. The feature attribute set including these attributes may be defined as the file feature value. Thus, in the process of analyzing the file characteristics of the file to be stored, when a vehicle is included in the picture, the brand and license plate number of the vehicle can be recorded in the file feature value. When a character appears in the picture, the characteristics such as the gender and the age of the character are recorded in the file feature value.

Moreover, in practical applications, other attributes of the file to be stored (such as file type, creation time and location of the file) may also be generated as corresponding file feature values, so that the file attributes can be more comprehensively recorded.

S12, the storage device generates a file feature value record according to the file feature value of the file to be stored, and stores the file feature value record and the corresponding relation between the file feature value record and the file to be stored to a preset mapping table.

After obtaining the file characteristics of the file to be stored, a file feature value record may be generated, and the file feature value record may be used to record the attributes of the file to be stored, and each file to be stored corresponds to a file feature value record. By storing the file feature value record and the corresponding relation between the file feature value record and the file to be stored in the preset mapping table, data management operations such as subsequent file retrieval and reading can be provided with a basis.

For example, file A (filename is A) is the file to be stored, and file feature value analysis is performed on file A to generate a corresponding file feature value record as “xyz”. The value of the attribute x is used to identify the brand of a vehicle. At this time, the corresponding content of the record in the mapping table may include “xyzA”.

Preferably, in some embodiments of the present disclosure, hash algorithms may also be employed to improve the storage efficiency of file (data) and the efficiency of the subsequent file retrieval and reading, the specific steps may be as follows:

Generating a corresponding hash value according to the file feature value of the file to be stored.

Establishing a bit mapping table of the filename of the file to be stored (or the physical address of the file to be stored in the storage device) and the hash value.

S13, when the storage device receives a data management instruction from the storage server, the storage device may generate a condition file feature value corresponding to the data management instruction. The condition file feature value is used to characterize a query condition corresponding to the data management instruction.

This step describes the process of file access and reading. In practical applications, typical data management instructions may be a retrieval instruction for querying a particular file. For example, the retrieval instruction may be used to query vehicle video files including brand name “Ford” from the video frame data. Usually, the retrieval instruction will generally include the query condition of “vehicle brand is Ford”.

At this time, according to the retrieval instruction, the condition file feature value of “vehicle brand” can be obtained, that is, the query condition of the current retrieval is that the value of “vehicle brand” should be “Ford”, that is, those storage files meet the above query condition are target files.

S14, the storage device may match the file feature value record in the preset mapping table according to the condition file feature value, and obtain the filename of the required target file or the physical address of the target file in the storage device.

The filename of corresponding target file can be found by a retrieval of filename according to the query condition. For example, video files including “Ford” vehicle can be conveniently queried. Of course, in some embodiments of the present disclosure, the setting of query condition can be set as desired, and different query conditions can be mapped to different file feature values, and different query conditions can be matching conditions for a file retrieval.

From the above, the storage system as provided in the embodiments of the present disclosure has a distributed processing structure, i.e., the storage server and the storage device both have a function of data processing. When storing a file, the file feature value of the file to be stored may be extracted, and the filename of the file to be stored may be correlated with the file feature value, then the file may be stored. Thus, when retrieving and reading files, the storage device can acquire or generate a corresponding file feature value according to a data management instruction of the storage server. Then, a corresponding target file may be obtained in the storage medium according to the file feature value as the matching parameter. Then the target file may be uploaded to the storage server.

Through the embodiments of the present disclosure, the data processing process for implementing data storage is divided, and the storage device performs data functions such as file feature value extraction and file feature value matching. By the process of file feature value extraction and matching of the storage file, firstly the search and retrieval efficiency of file can be improved, and the required file can be conveniently and accurately obtained, thereby improving the efficiency of file retrieval. On the other hand, since the embodiments of the present disclosure can perform preliminary processing of file management in the storage device, files can be preliminarily filtered. The preliminary filtering can effectively reduce the amount of data transmission from the storage device to the storage server, so it can also effectively reduce the network load of the entire storage system and improve the transmission efficiency of effective files, thus improving efficiency of the storage system from another aspect.

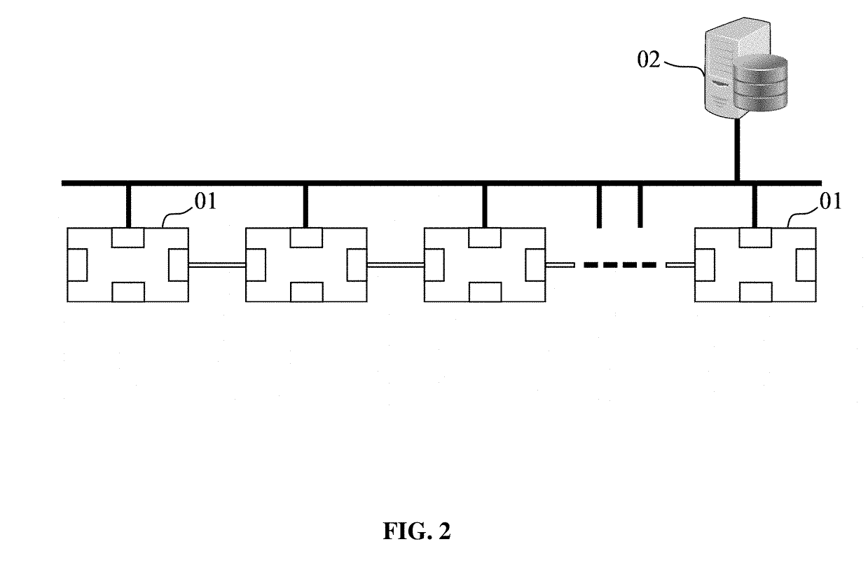

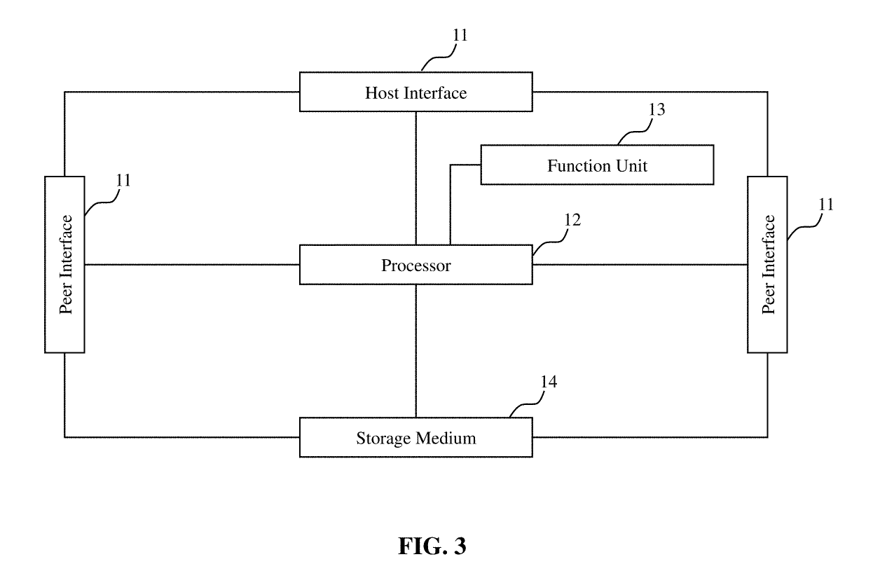

In another aspect of the embodiments of the present disclosure, a storage device based on feature analysis is further provided. Referring to FIG. 2 and FIG. 3, the storage device includes a data interface 11, a processor 12, a functional unit 13, and a storage medium 14 for storing files.

The data interface 11 includes a host interface for data interaction with the storage server 02.

The function unit 13 includes a feature analysis module (not shown) for performing file feature value analysis on a file to be stored obtained from the storage server 02 and obtaining the file feature value of the file to be stored before storing the file to be stored. The file feature value is a feature attribute set predefined based on a preset rule and configured to characterize attributes of the file to be stored. The feature attribute set includes a content characteristic subset for characterizing the content characteristics of the file to be stored. The function unit 13 also includes an association module (not shown) for creating and storing a mapping relation between the file feature value and the filename of the file to be stored. The function unit 13 also includes an instruction parsing module (not shown) for generating a file feature value corresponding to a query instruction when the storage device receives the query instruction from the storage server 02. The function unit 13 also includes a matching module (not shown) for matching the file feature value according to the correspondence between the file feature value and the filename of the file to be stored, and obtain the filename of a target file and obtain the target file.

The processor 12 is configured to provide data processing capability for each of the modules in the functional unit 13.

In the embodiments of the present disclosure, the core idea is to distributedly design the data management process of the entire storage system to be implemented in a server and a terminal. Specifically, part of the processing can be performed by the storage server 02 (as a server), the other part of the processing can be performed by the storage device 01 (as a terminal). For example, local data management which can be performed by the storage device 01 may include query, classification, analysis, hash computation, and data conversion of data. In other words, the operations and processing of data management are not performed by the storage server 02.

It should be noted that the data processing methods of local data management as described in the present disclosure (query, classification, analysis, hash computation, and data conversion) are only typical examples of specific applications of data management processing performed by the storage device 01, and not limited herein. Persons having ordinary skills in the art can design the processing functionality based on actual needs, the design shall fall into the protecting scope of the embodiments of the present disclosure.

As a part of a storage system, the storage device in the embodiments of the present disclosure cooperatively implements file storage and retrieval through network communication with a storage server. In actual applications, one storage server can simultaneously connect with multiple storage devices through network to form a storage system.

The storage device in the embodiments of the present disclosure performs part of function of arithmetic and processing, which not only can share the computing load of the storage server, but also can effectively reduce the network load of the storage system. For this reason, in terms of the hardware composition of the storage device in the embodiment of the present disclosure, not only the data interface 11 for communicating with the storage server 02 and the storage entity of the data file (ie, the storage medium 14) are required, but also the processor 12 and the functional unit 13 are required. The processor 12 is used to implement arithmetic and processing of the data, the functional unit 13 may be software for implementing the data file management function in the embodiments of the present disclosure. Of course, the functional software may also be composed of hardware. As long as the data file management function of the storage device 01 can be implemented.

In some embodiments of the present disclosure, particularly the storage medium 14 may include a storage unit of flash memory type. In order to further reduce the network load of the entire storage system, the storage device may further include a peer interface configured to communicate with adjacent storage devices in the data storage system.

In some embodiments, the host interface includes one or any combination of interfaces of PCIe interface, SAS interface, SATA interface, RAPID-IO interface, and NVMe interface. The peer interface includes one or any combination of interfaces of Ethernet interface, FC interface, iSCSI interface and SAN interface.

The specifics of the functional unit 13 can be described as follows:

In the embodiments of the present disclosure, operations such as file (data) storing and file (data) reading based on different applications may be implemented by the storage system, for example, storing video frame files acquired by a camera.

When the storage device 01 is the executor, the process of file access includes a file storage process and a file retrieval process.

According to the instruction of the storage server 02, the storage device 01 can receive a file to be stored. Before storing the file to be stored, the feature analysis module first performs file feature value analysis on the file to be stored to obtain the file feature value of the file to be stored. In some embodiments, the file feature value refers to a predefined feature attribute set configured to characterize the attributes of the file to be stored. In practical applications, the attributes may be various and are defined according to different applications. When the file to be stored is an image file including a character. The attributes may include the age, gender, and appearance of the character. When the file to be stored is an image file including a vehicle, the attributes may include a brand and a license plate number of the vehicle. For example, for video frame files obtained by a camera, the content characteristic in the picture of the video frame may be defined as the file feature value. Specifically, the brand and the license plate number of the vehicle may be predefined as the file feature value respectively. Meanwhile the gender, age, or appearance of the character may also be predefined as the file feature value. The feature attribute set including these attributes may be defined as the file feature value. Thus, in the process of analyzing the file characteristics of the file to be stored, when a vehicle is included in the picture, the brand and license plate number of the vehicle can be recorded in the file feature value. When a character appears in the picture, the characteristics such as the gender and the age of the character are recorded in the file feature value.

Moreover, in practical applications, other attributes of the file to be stored (such as file type, creation time and location of the file) may also be generated as corresponding file feature values, so that the file attributes can be more comprehensively recorded.

After obtaining the file characteristics of the file to be stored, a file feature value record may be generated, and the file feature value record may be used to record the attributes of the file to be stored, and each file to be stored corresponds to a file feature value record. By storing the file feature value record and the corresponding relation between the file feature value record and the file to be stored in the preset mapping table, data management operations such as subsequent file retrieval and reading can be provided with a basis.

For example, file A (filename is A) is the file to be stored, and file feature value analysis is performed on file A to generate a corresponding file feature value record as “xyz”. The value of the attribute x is used to identify the brand of a vehicle. At this time, the corresponding content of the record in the mapping table may include “xyzA”.

Preferably, in some embodiments of the present disclosure, hash algorithms may also be employed to improve the storage efficiency of file (data) and the efficiency of the subsequent file retrieval and reading, the specific steps may be as follows:

Generating a corresponding hash value according to the file feature value of the file to be stored;

Establishing a bit mapping table of the filename of the file to be stored (or the physical address of the file to be stored in a storage device) and the hash value.

In practical applications, typical data management instructions may be a retrieval instruction for querying a particular file. For example, the retrieval instruction may be used to query vehicle video files including brand name “Ford” from the video frame data. Usually, the retrieval instruction will generally include the query condition of “vehicle brand is Ford”.

At this time, according to the retrieval instruction, the condition file feature value of “vehicle brand” can be obtained, that is, the query condition of the current search is that the value of “vehicle brand” should be “Ford”, that is, those storage files meet the above query condition are target files.

The matching module matches the file feature value record in the preset mapping table according to query condition, and obtains the filename of the required target file or the physical address of the target file in the storage device. For example, video files including “Ford” vehicle can be conveniently queried. Of course, in some embodiments of the present disclosure, the setting of query condition can be set as desired, and different query conditions can be mapped to different file feature values, and different query conditions can be matching conditions for a file retrieval.

From the above, the storage system as provided in the embodiments of the present disclosure is a distributed processing structure, i.e., the storage server and the storage device both have a function of data processing. When storing a file, the file feature value of the file to be stored may be extracted, and the filename of the file to be stored may be correlated with the file feature value, then the file may be stored. Thus, when retrieving and reading files, the storage device can acquire or generate a corresponding file feature value according to a data management instruction of the storage server. Then, a corresponding target file may be obtained in the storage medium according to the file feature value as the matching parameter. Then the target file may be uploaded to the storage server.

Through the embodiments of the present disclosure, the data processing process for implementing data storage is divided, and the storage device performs data functions such as file feature value extraction and file feature value matching. By the process of file feature value extraction and matching of the storage file, firstly the search and retrieval efficiency of file can be improved, and the required file can be conveniently and accurately obtained, thereby improving the efficiency of file retrieval. On the other hand, since the embodiments of the present disclosure can perform preliminary processing of file management in the storage device, files can be preliminarily filtered. The preliminary filtering can effectively reduce the amount of data transmission from the storage device to the storage server, so it can also effectively reduce the network load of the entire storage system and improve the transmission efficiency of effective files, thus improving efficiency of the storage system from another aspect.

In another aspect of the present disclosure, a storage system is further provided. Referring to FIG. 2 and FIG. 3, the storage system includes a storage device 01 and a storage server 02.

The technical solutions, the working principles, and the beneficial effects that can be achieved in the embodiments of the present disclosure have been described in the foregoing embodiments of the storage device, and are not described herein again.

It will be appreciated that the systems, apparatuses, and methods disclosed in embodiments herein may also be implemented in various other manners. For example, the above apparatus embodiments are merely illustrative, e.g., the division of units is only a division of logical functions, and there may exist other ways of division in practice, e.g., multiple units or components may be combined or may be integrated into another system, or some features may be ignored or not included. In other respects, the coupling or direct coupling or communication connection as illustrated or discussed may be an indirect coupling or communication connection through some interface, device or unit, and may be electrical, mechanical, or otherwise.

Separated units as illustrated may or may not be physically separated. Components or parts displayed as units may or may not be physical units, and may reside at one location or may be distributed to multiple networked units. Some or all of the units may be selectively adopted according to practical needs to achieve desired objectives of the disclosure.

Additionally, various functional units described in embodiments herein may be integrated into one processing unit or may be present as a number of physically separated units, and two or more units may be integrated into one. The integrated units above can be implemented by means of hardware or as software functional units.

If the integrated units are implemented as software functional units and sold or used as standalone products, they may be stored in a computer readable storage medium. Based on such an understanding, the essential technical solution, or the portion that contributes to the prior art, or all or part of the technical solution of the disclosure may be embodied as software products. Computer software products can be stored in a storage medium and may include multiple instructions that, when executed, can cause a computing device, e.g., a personal computer, a server, a network device, etc., to execute some or all operations of the methods as described in the various embodiments. The above storage medium may include various kinds of media that can store program code, such as a universal serial bus (USB) flash memory disk, a mobile hard drive, a read-only memory (ROM), a random access memory (RAM), a resistance random access memory (ReRAM), a magnetic random access memory (MRAM), a pulse-code modulation (PCM), a NAND flash memory, a NOR flash memory, a memristor, a magnetic disk, or an optical disk.

In summary, the above embodiments are used to describe the technical solutions of the present disclosure, and do not intend to limit herein. While the present has been described in detail referring to the embodiments above, persons having ordinary in the art should understand, various modifications and equivalent arrangements of the technical solutions of the above embodiments may be conducted. However, the modifications and equivalent arrangements may not depart from the protecting scope and spirit of the present disclosure.

What is claimed is:

1. A storage system, comprising:
a storage server; and
a plurality of storage devices, each comprising:
a data interface comprising a host interface configured receive a file to be stored in the storage device and a data management instruction from the storage server;
a storage medium configured to store the file; and
a function unit implemented by a processor, comprising:
a feature analysis module configured to determine a file feature value of the file for characterizing a feature attribute set based on a preset rule prior to storing the file, wherein the feature attribute set characterizes content characteristics of the file;
an association module configured to generate a file feature value record based on the file feature value of the file, and store the file feature value record and a corresponding relation between the file feature value record and the file into a mapping table;
an instruction parsing module configured to generate a condition file feature value corresponding to the data management instruction received from the storage server, wherein the condition file feature value characterizes a query condition of the data management instruction; and
a matching module configured to obtain a target file based on matching of the condition file feature value and the corresponding file feature value record in the mapping table.

2. The storage system of claim 1, wherein the data interface further comprises a peer interface configured to communicate with another storage medium of an adjacent storage device in the storage system.

3. The storage system of claim 1, wherein the feature attribute set comprises at least one of an acquisition time, an acquisition location, or a file type of the file.

4. The storage system of claim 1, wherein the feature attribute set comprises:
at least one of an age, a gender, or an appearance of a character when the file is an image file including the character; and
at least one of a brand or a license plate number of a vehicle when the file is an image file including the vehicle.

5. The storage system of claim 1, wherein the association module is further configured to:
generate a hash value based on the file feature value of the file; and
establish a bit mapping table of a filename of the file or a physical address of the file in the storage device and the hash value.

6. The storage system of claim 1, wherein the data management instruction comprises a retrieval instruction for querying the target file based on the query condition.

7. The storage system of claim 1, wherein the matching module is further configured to obtain a filename of the target file or a physical address of the target file in the storage device.

8. The storage system of claim 1, wherein the storage medium comprises a storage unit of flash memory type.

9. The storage system of claim 2, wherein
the host interface comprises at least one of a PCIe interface, a SAS interface, a SATA interface, a RapidIO interface, or a NVMe interface; and
the peer interface comprises at least one of an Ethernet interface, a FC interface, an iSCSI interface, or a SAN interface.

10. A storage device, comprising:
a data interface comprising a host interface configured receive a file to be stored in the storage device and a data management instruction from a storage server;
a storage medium configured to store the file; and
a function unit implemented by a processor, comprising:
a feature analysis module configured to determine a file feature value of the file for characterizing a feature attribute set based on a preset rule prior to storing the file, wherein the feature attribute set characterizes content characteristics of the file;
an association module configured to generate a file feature value record based on the file feature value of the file, and store the file feature value record and a corresponding relation between the file feature value record and the file into a mapping table;
an instruction parsing module configured to generate a condition file feature value corresponding to the data management instruction, wherein the condition file feature value characterizes a query condition of the data management instruction; and
a matching module configured to obtain a target file based on matching of the condition file feature value and the corresponding file feature value record in the mapping table.

11. The storage device of claim 10, wherein the storage medium comprises a storage unit of flash memory type.

12. The storage device of claim 10, wherein the data interface further comprises a peer interface configured to communicate with another storage medium of an adjacent storage device in a storage system comprising the storage server.

13. The storage device of claim 12, wherein
the host interface comprises at least one of a PCIe interface, a SAS interface, a SATA interface, a RapidIO interface, or a NVMe interface; and
the peer interface comprises at least one of an Ethernet interface, a FC interface, an iSCSI interface, or a SAN interface.

14. A method for data access based on feature analysis, comprising:
receiving, by a storage device, a file to be stored in the storage device from a storage server;
determining, by the storage device, a file feature value of the file for characterizing a feature attribute set based on a preset rule prior to storing the file, wherein the feature attribute set characterizes content characteristics of the file;
generating, by the storage device, a file feature value record based on the file feature value of the file;
storing, by the storage device, the file feature value record and a corresponding relation between the file feature value record and the file into a mapping table;
receiving, by the storage device, a data management instruction from the storage server;
generating, by the storage device, a condition file feature value corresponding to the data management instruction, wherein the condition file feature value characterizes a query condition of the data management instruction; and
obtaining, by the storage device, a target file based on matching of the condition file feature value and the corresponding file feature value record in the mapping table.

15. The method of claim 14, wherein the content characteristics comprise at least one of an acquisition time, an acquisition location, or a file type of the file.

16. The method of claim 14, wherein the feature attributes set comprises:
at least one of an age, a gender, or an appearance of a character when the file is an image file including the character; and
at least one of a brand or a license plate number of a vehicle when the file is an image file including the vehicle.

17. The method of claim 14, wherein the storing comprises:
generating a hash value based on the file feature value of the file; and
establishing a bit mapping table of a filename of the file or a physical address of the file in the storage device and the hash value.

18. The method of claim 14, wherein the data management instruction comprises a retrieval instruction for querying the target file based on the query condition.

19. The method of claim 14, wherein the obtaining comprises obtaining a filename of the target file or a physical address of the target file in the storage device.

20. The method of claim 14, further comprising uploading, by the storage device, the target file to the storage server.
